(19) United States
(12) Patent Application Publication
(10) Pub. No.: US 2019/0267810 A1
(43) Pub. Date: Aug. 29, 2019

(54) HVDC/MVDC Systems and Methods with Low-Loss Fully-Bidirectional BJT Circuit Breakers

(71) Applicant: Ideal Power, Inc., Austin, TX (US)

(72) Inventor: David M. Johns, Briarcliff, TX (US)

(73) Assignee: Ideal Power, Inc., Austin, TX (US)

(21) Appl. No.: 16/288,016

(22) Filed: Feb. 27, 2019

Related U.S. Application Data
(60) Provisional application No. 62/636,030, filed on Feb. 27, 2018.

(51) Int. Cl. H02J 3/36; H02B 7/06; H02M 3/155; H02M 1/08; H02B 1/24

(52) U.S. Cl. CPC H02J 3/36; H02B 7/06; H02B 1/24; H02M 1/08; H02M 3/155

(57) ABSTRACT

Methods and systems for HVDC and/or MVDC power transmission and/or distribution, using circuit breakers where a series-connected stack of fully-bidirectional bipolar junction transistors is the initial interrupter in the current path. Preferably these transistors are operated with two pre-turnoff phases, to deplete minority carrier population and thus provide a faster transition to complete turnoff.

### CROSS-REFERENCE

Priority is claimed from U.S. provisional application 62/636,030, filed Feb. 27, 2018, which is hereby incorporated by reference.

### BACKGROUND

The present application relates to High-Voltage DC (HVDC) power systems and methods, and more particularly to HVDC and MVDC circuit breakers. Note that the points discussed below may reflect the hindsight gained from the disclosed inventions, and are not necessarily admitted to be prior art.

There are many ways to generate electric power, but all are useless unless the power can be delivered to the point where it is needed. Conventionally this is done by stepping up the as-generated voltage (e.g. 2400V) to a high voltage (e.g. 115 kV to 230 kV or more), which is connected to high-voltage transmission lines. The transmission lines carry power to primary distribution substations, where the high voltage is transformed down to “feeder voltage” (e.g. 2400V-13800V or more) for transmission to secondary distribution transformers. The secondary distribution transformer will further transform the voltage down to a “service voltage” (e.g. 240V split-phase or 480V three-phase) for connection to the customer's meter. For customers who use larger quantities of power, the power can be supplied at “subtransmission” or “primary distribution” voltages.

The fundamental advantage of higher voltages is that resistive losses are proportional to current squared; transformation to higher voltage implies lower current, and thus reduces losses. The fundamental disadvantage of higher voltages is that voltage-induced breakdown is always a consideration. This is particularly the case with switches, since individual solid-state switches are limited, with current technology, to a few tens of kV. Series-connected stacks of components can be used to switch higher voltages, but such stacks require care to assure that no switch receives an excessive fraction of the total voltage.

FIG. 4 illustrates the high-level topology of conventional power distribution, and sample voltages. What is shown (very schematically) is the complete architecture of Generation, Transmission, and Distribution (“GTD”). The generating station 310 can be coal-fired, oil-fired, gas-fired, nuclear, wind, solar, process-heat-driven, tidal, or anything else. The as-generated voltage is stepped up by transformer 311 to a much higher transmission voltage, to reduce ohmic losses during transmission over lines 312. Some industrial customers 313 may choose to receive power at the high voltages of the transmission lines 312. Substations 314 convert the power to a lower voltage, and send it over primary distribution lines 315. These primary distribution lines are routed to distribute power over a significant area, e.g. over a small city. “Medium” voltage, lower than 33 kV, is normally used for distribution.

Some large customers 316 (e.g. commercial or government or industrial) may choose to receive their power at the medium voltage which is used for primary distribution, or even at a high voltage (referred to as a “subtransmission” voltage). However, the vast majority of customers 319 will receive power through secondary distribution lines 318 which are connected to a secondary transformer 317. The secondary distribution voltage will normally be a low voltage, typically 600V or less. In the US, residential customers will typically receive 240V split-phase power, or sometimes 208V three-phase power; businesses commonly receive 480V 3-phase power.

An important part of this architecture is not shown: overvoltage protection will typically be located at various locations in the power network, e.g. near switchgear. Such overvoltage protection can be provided by varistors or by vacuum components. This provides protection against transients due to lightning strikes.

Typical secondary distribution topology varies among countries. In the US, for example, a single secondary distribution transformer may serve only one or a few residential users, and can therefore have a power capacity as low as 20 kW. In the UK, by contrast, a single secondary distribution transformer would normally be rated between 315 kVA and 1 MVA, and supply a whole neighbourhood. These are not strict limits, but are mentioned because the inventions described below can have different advantages in these different contexts. In very densely populated areas, “secondary networks” are sometimes used, with many distribution transformers feeding a “grid” at the utilization voltage. This improves reliability since many distribution transformers share the collected load.

### DC Versus AC

The conventional power GTD architecture, as described above, makes heavy use of transformers. However, it was not always apparent that transformers would play a part at all. Even after the “War of the Currents” in the late 19^{th} century, DC power distribution remained in some cities up to the 1940s or later. There are still large apparent benefits to DC power in some parts of the system, as will be explained below.

The overwhelming advantage of AC power was the ability of (relatively) simple transformers to convert voltage with reasonable efficiency. Thus consumers' line voltage (and current limit) can be optimized for safety (e.g. +/−120V in the US), while the local distribution voltage is optimized to provide a higher voltage (e.g. 2400V) which is more efficient while still avoiding risk from local overhead lines. (Ohmic losses depend on current, so transforming power to a higher voltage means fewer ohmic losses.) Still higher voltages can be used between substations, and the highest voltages are used for power transmission (e.g. from 130 kV up to a megavolt or more).

However, DC power distribution still has many advantages over AC power distribution. (See Kostoulas et al., “DC Circuit Breakers and Their Use in HVDC Grids”, which is hereby incorporated by reference.) Notably, DC transmission or distribution makes more efficient use of the conductor metal (e.g. copper), since none of the available line conductance has to be used for reactive power. Moreover, line conductance is not limited by skin effect. Moreover, a DC tie can add stability to a boundary between power grid domains.

Modern solid-state power converters can be designed to handle the voltages needed for MVDC or HVDC. However, there are some significant differences from the design of conventional power systems, and some of these differences produce major challenges in engineering.

One important one is interrupting current. The waveform of AC current necessarily has zero crossings, so when it is necessary to interrupt a circuit, the interruption can be timed to happen at a current zero. The inductance of the line will store energy which will tend to produce a rising voltage across the breaker when the breaker is opened; with AC power, optimal timing can give the breaker some milliseconds to transition into its open state before the induced voltage on the breaker rises to its peak value. By contrast, with DC power there are no predictable zero crossings. If a solid-state switch is able to transition very rapidly into its off state, then a snubbing circuit

### Large-Battery Utility Backup

A recent development has been the rise of Grid Energy Storage. Large utilities have made initial installations of power-storage battery banks. The cost of stationary batteries continues to decline, so this trend is expected to continue. A connection to such a backup battery must allow for bidirectional flow of power.

### Distributed-Generation Topologies

Another recent trend is the use of distributed generation. In many places, this is strongly encouraged by local or regional governments, partly because customers' power sources are often based on green energy (solar, wind, or water). An important point about such architecture is that a connection to a generation/load node must be able to handle bidirectional power transfer.

### HVDC Breakers

A fundamental technology requirement which presently limits the implementation of DC power grids is the lack of a suitable HVDC circuit breaker (See e.g. Christian M. Franck, “HVDC Circuit Breakers: A Review Identifying Future Research Needs”, which is hereby incorporated by reference.) Several approaches have been tried.

Mechanical breakers have relatively slow response times compared to solid state switches, and require complex mechanisms to quench arcing between the contacts and commutation of fault currents.

Historically mercury arc tubes were used for HVDC converters, but that technology is unsafe and impractical nowadays.

Hybrid breakers, which use a semiconductor switch to help a mechanical breaker to the open state, have been proposed by ABB. See e.g. the ABB press materials at https://resources.news.e.abb.com/attachments/published/13081/en-US/D81A3D8FA006/HV-Hybrid-DC-Breaker.pdf. (All of the linked materials, in their state as of 26 Feb. 2019, are hereby incorporated by reference.) However, these subsystems are complex and somewhat expensive.

Thyristors have been used in HVDC circuit breakers, and have low on state conduction losses, but suffer from switching characteristics which require limiting current slew rates (di/dt). Unless an MCT or GTO thyristor is used, additional elements may be needed for proper turn-off.

IGBTs have excellent switching characteristics for HVDC breaker applications, but IGBTs suffer high forward conduction losses, requiring complex cooling schemes like pumped liquid cooling, and active control of the fluid conductivity. (See M. Kempkes et. al., “Solid-State Circuit Breakers For Medium Voltage DC Power”, which is hereby incorporated by reference.)

Although symmetric thyristors exist, they are not as common as asymmetric thyristors. IGBTs are asymmetric; so incorporation of a solid state DC circuit breaker in DC distribution networks with power regeneration capability requires additional system complexity (blocking diodes and anti-parallel orientation of duplicate circuits).

### HVDC/MVDC Systems and Methods with Low-Loss Fully-Bidirectional BJT Circuit Breaker

The present application teaches, among other innovations, HVDC systems, subsystems, components, circuits, and methods in which Low-Loss Fully-Bidirectional bipolar junction transistors are used to implement circuit breakers. These solid-state devices are fully bidirectional, and have a very low forward voltage drop.

Preferably these transistors are used in a series combination, with a voltage divider helping to equalize the drops on the individual transistors.

Preferably, but not necessarily, these transistors (or a series combination of them) provide an HVDC breaker without any mechanical breaker at all.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1A schematically shows an example of a bidirectional HVDC breaker as described herein, and FIG. 1B shows an example of a power distribution architecture using breakers like the one in FIG. 1A.

FIG. 1C shows a complete power GTD (generation, transmission, and distribution) architecture, which advantageously uses the breaker of FIG. 1A.

FIG. 1D shows another complete power GTD (generation, transmission, and distribution) architecture, which advantageously uses the breaker of FIG. 1A.

FIG. 2 shows an example of a Fully-Bidirectional Bipolar Junction transistor (BJT) which is advantageously used in the circuit breaker of FIG. 1A.

FIGS. 3A-3F show a first sequence of operation for the transistor of FIG. 2.

FIG. 4 illustrates the high-level topology of conventional power distribution, with sample voltages.

FIGS. 5A-5E illustrate a modification of the sequence of FIGS. 3A-3F.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

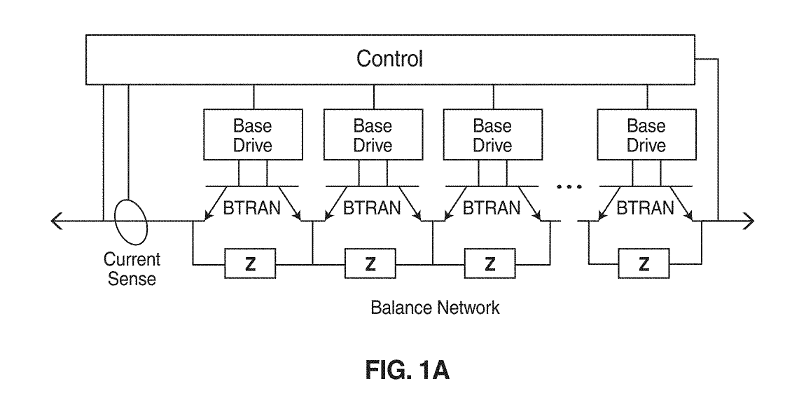

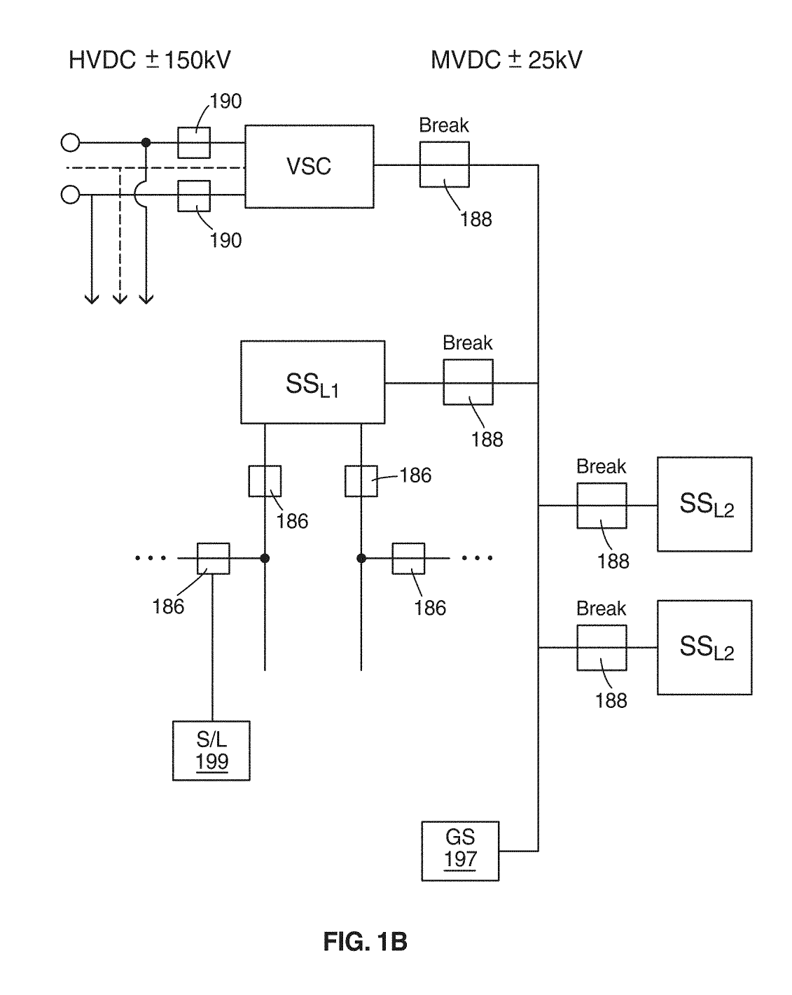

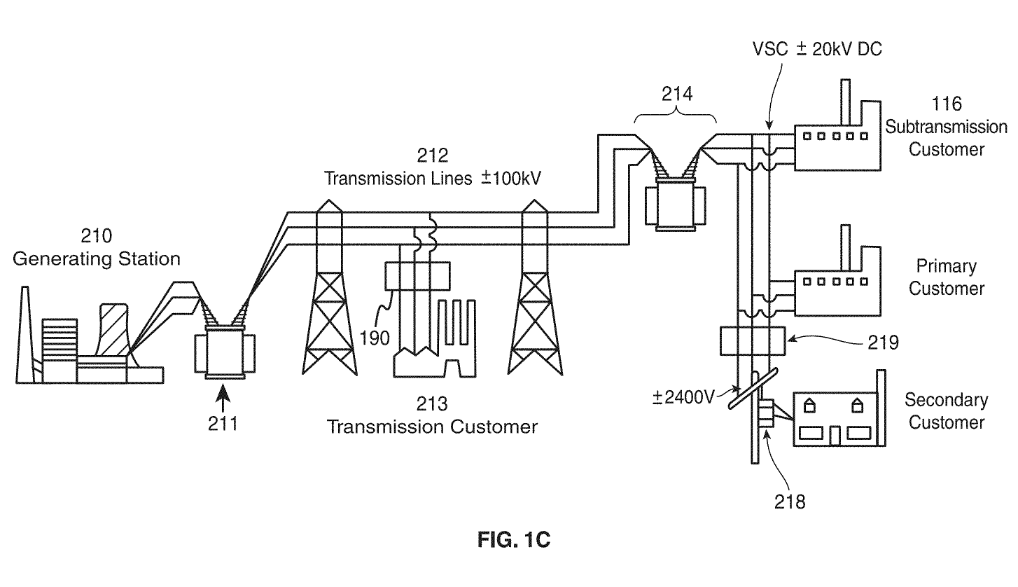

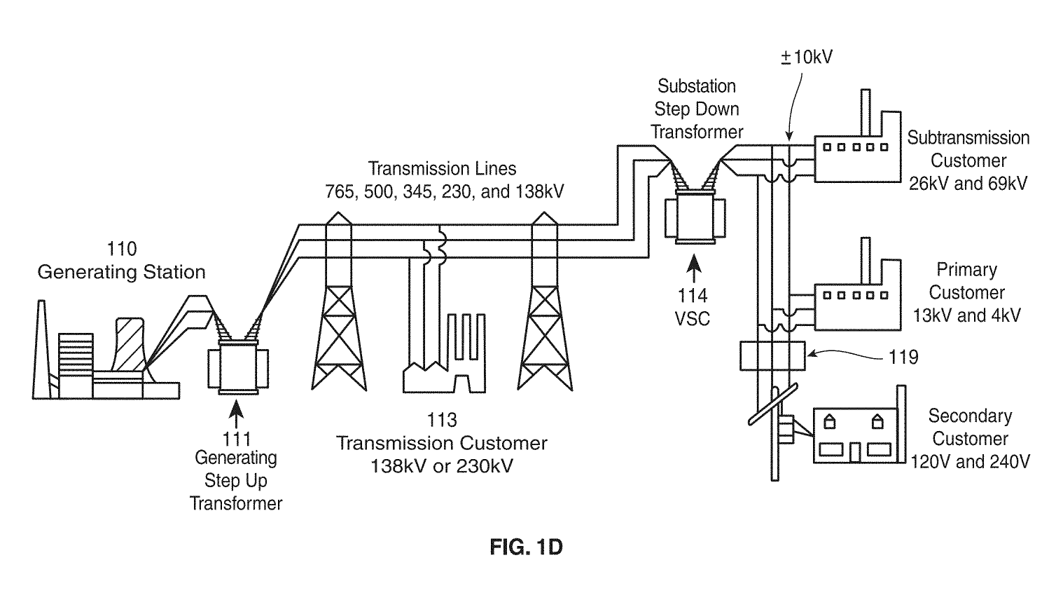

FIG. 1B shows a power distribution architecture, which advantageously uses the breaker of FIG. 1A to implement MVDC distribution, e.g. at +/−10 kV in a bipolar arrangement.

In this example, the breakers are labelled differently at different points in the distribution tree, since different voltage ratings would be used. In this example, the incoming transmission line is +/−150 kV, i.e. is a high voltage line. HVDC breakers 190 permit the voltage-source-converter 192 to be isolated from the high voltage line. These breakers have to withstand more than 150 kV line voltage, so the implementation will preferably use high-voltage individual devices (e.g. at least 5 kV, and preferably more). For example, if 20 kV SiC B-TRAN devices are used, a stack of ten will be needed to achieve 200 kV breakdown.

Note, however, that the distribution tree can have different current types at different levels, and the example given are merely illustrative.

Converter 192 provides a MVDC output. This is shown as only a single line, even though it would typically include two power lines plus an electrode line. Voltage in this example is given as +/−10 kV, which is at the low end of the MVDC range.

The MVDC line, in this example, is connected to at least three substations, labelled SS_{L1} and SS_{L2}, through breakers 188. The breakers 188 can include lower-voltage devices in a shorter string, since the line voltage is much less than the HVDC breaker.

Note that the MVDC line is also connected, through another breaker 188, to a grid storage unit 197. This can be, for example, a battery bank.

Substation SS_{L1} is assumed to require more power than the substations SS_{L2}, even though all are supplied at the same voltage. Substation SSL1 is connected through breakers 186 to supply local customers 199. At least some of the customers 199 may be intermittent power suppliers.

FIG. 1C shows a complete power GTD (generation, transmission, and distribution) architecture, which advantageously uses the breaker of FIG. 1A to implement HVDC transmission, e.g. at +/−100 kV in a bipolar arrangement. A VSC 211 connects the generation station 210 to HVDC lines 212. A large customer 213 is also connected to lines 212 through a pair of HVDC breakers 190, as described above. Another VSC 214 supplies power to an MVDC bus, operating e.g. at +/−20 kVDC. Primary and subtransmission customers (315 and 316 respectively) are connected to the MVDC bus through MVDC breakers 188 as described above. Finally, another converter 219 generates AC power for local distribution, including to transformers 218 which supply secondary customers.

FIG. 1D shows another complete power GTD (generation, transmission, and distribution) architecture, which advantageously uses the breaker of FIG. 1A to implement MVDC distribution, e.g. at +/−10 kV in a bipolar arrangement. In this example the transmission lines 212 carry AC power rather than HVDC. Conversion to MVDC is performed by a substation converter 114. Supply of the subtransmission, primary, and secondary customers is the same as in FIG. 1C above.

### B-TRAN Implementation

The BTRAN device performance characteristics make it uniquely suited for DC power distribution circuit breaker applications. The forward drop loss of the BTRAN is 70% to 90% lower than that of an IGBT which significantly reduces the cooling requirements, increasing system level efficiency, and reducing hardware complexity and cost. The symmetric voltage blocking capability of the BTRAN enables the application of the device to regenerative DC distribution systems without doubling (or more) solid state breaker material complexity and cost.

Low voltage DC power distribution systems may use a single BTRAN device. However, as seen in e.g. FIG. 1A, multiple devices may be stacked in series to enable application to higher voltage systems including the 10 to 20 kV medium voltage class. The device may also be realized in wide bandgap materials such as SiC or GaN to achieve higher junction holdoff voltage in a single device.

Published U.S. application US 2014-0375287 (which is hereby incorporated by reference) disclosed a fully bidirectional bipolar transistor with two base terminals. Such transistors are referred to as “B-TRANs.” The base region of the transistor is preferably the bulk of a semiconductor die. The transistor preferably has two emitter/collector regions, one on each face of the die. Two distinct base contact regions are also provided—one on each face of the die. Thus, for example, with a p-type semiconductor die, each face would include an n+ emitter/collector region and a p-type base contact region. Isolation trenches and peripheral field-limiting rings are preferably also included, but in essence the B-TRAN is a four-terminal three-layer device.

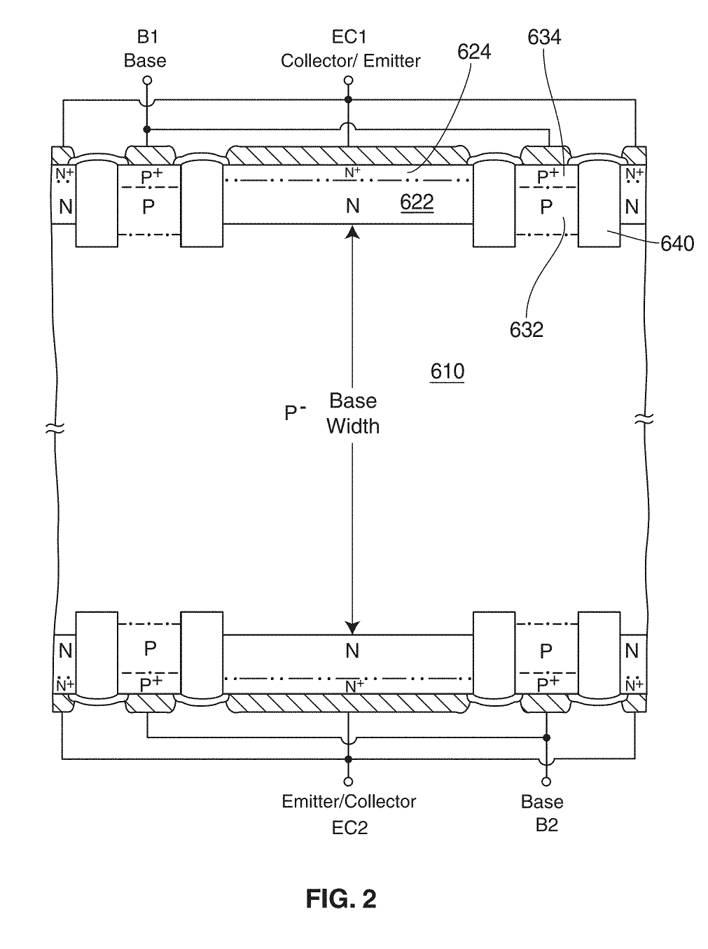

An example of a Fully-Bidirectional Bipolar Junction transistor “B-TRAN”) suitable for use in the breaker of FIG. 1A is generally illustrated in FIG. 2. In this Figure, both faces of a semiconductor die carry emitter/collector regions which form a junction with the bulk substrate. Base contact regions are also present on both faces. This example shows an npn structure, so the emitter/collector regions are n-type, and the base contact regions are p-type. A shallow n+ contact doping provides ohmic contact from the separate emitter/collector terminals (on the two opposite faces of the semiconductor die, in this example) to the emitter/collector regions, and a shallow p+ contact doping provides ohmic contact from the separate base terminals (on the two opposite faces of the die) to the base contact regions. In this example, the dielectric-filled trenches provide lateral separation between the base contact regions and the emitter/collector regions. However, each trench can also include a conducting region, such as doped polysilicon, that is surrounded by a dielectric, and is electrically connected to the emitter/collector to form a vertical field plate, increasing breakdown voltage. (Note that a p-type diffused region may be added to reduce the series resistance between the emitter-to-base junction and the base contact.) B-TRANs can provide significantly better efficiency than is conventionally available for existing static transfer switches; for example, a 1200V B-TRAN has an expected system efficiency of 99.9%.

Application US 2014-0375287 also describes some surprising aspects of operation of this kind of device. Notably: 1) when the device is turned on, it is preferably first operated merely as a diode, and base drive is then applied to reduce the on-state voltage drop. 2) Base drive is preferably applied to the base nearest whichever emitter/collector region will be acting as the collector (as determined by the external voltage seen at the device terminals). This operation is very different from typical bipolar transistor operation, where the base contact is (typically) closely connected to the emitter-base junction but may be far from the collector contact. 3) A two-stage turnoff sequence is preferably used. In the first stage of turnoff, the transistor is brought out of full bipolar conduction, but still is connected to operate as a diode; in the final state of turnoff diode conduction is blocked too. 4) In the off state, base-emitter voltage (on each side) is limited by an external low-voltage diode which parallels that base-emitter junction. This prevents either of the base-emitter junctions from getting anywhere close to forward bias, and avoids the degradation of breakdown voltage which can occur otherwise.

Since the B-TRAN is a fully symmetric device, there is no difference between the two emitter/collector regions. However, in describing the operation of the device, the externally applied voltage will determine which side is (instantaneously) acting as the emitter, and which is acting as the collector. The two base contact terminals are accordingly referred as the “e-base” and “c-base”, where the c-base terminal is on the side of the device which happens to be the collector side at a given moment.

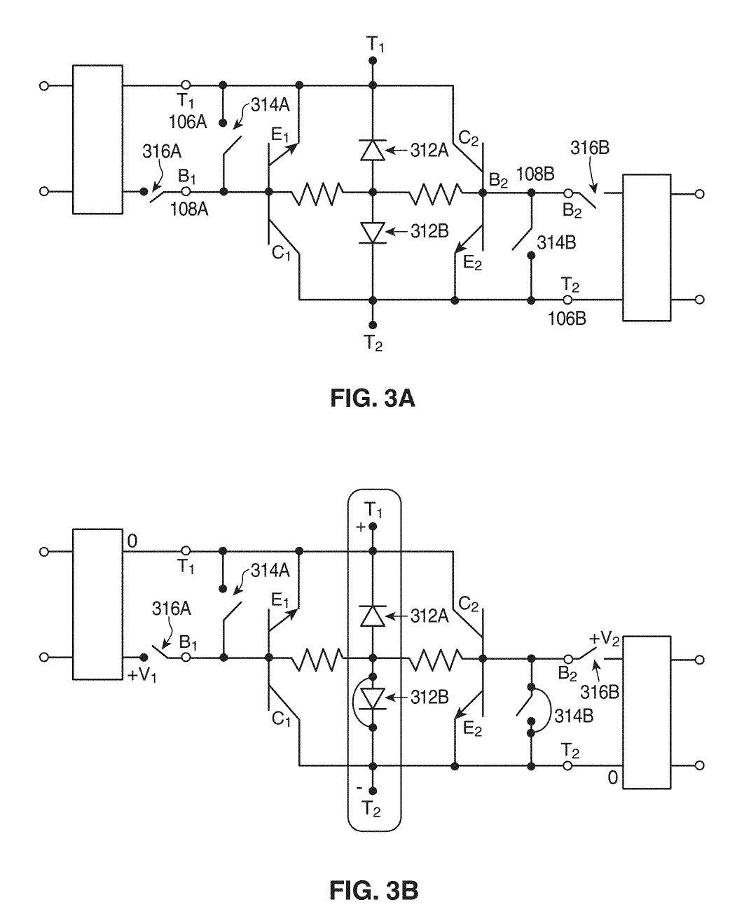

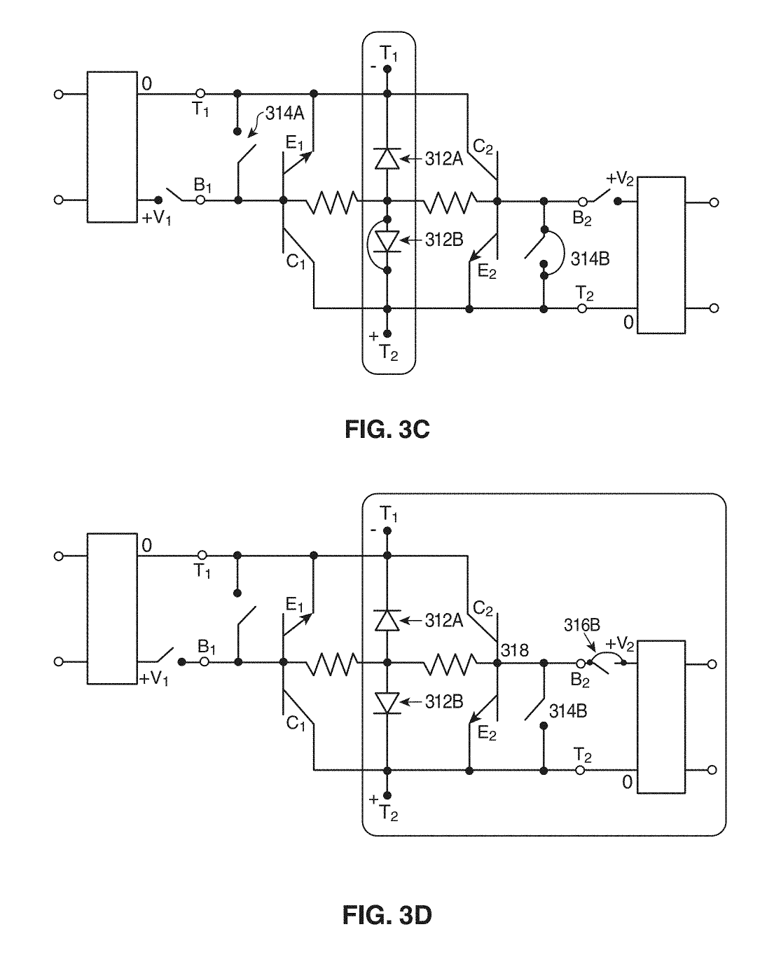

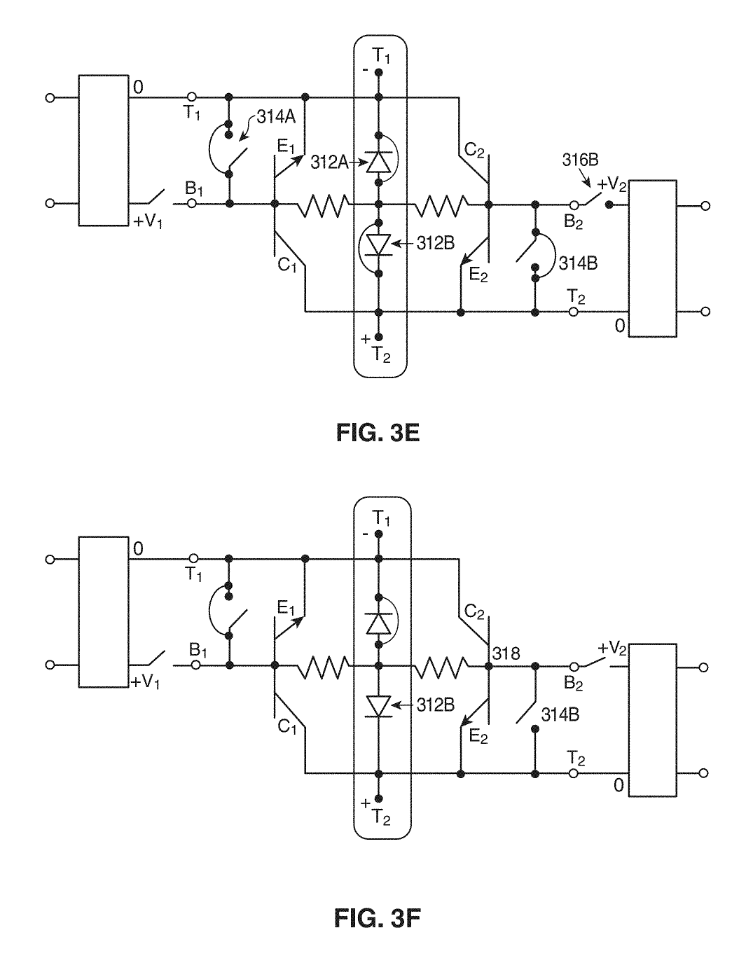

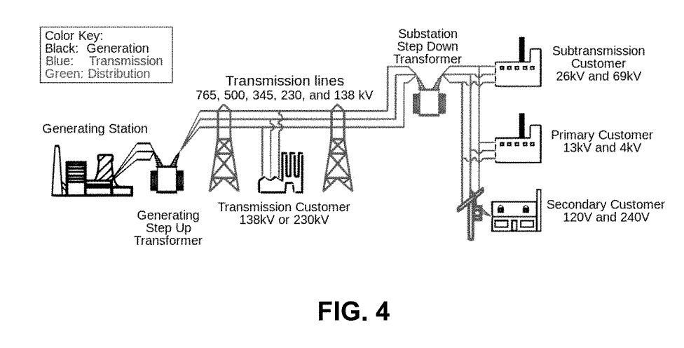

FIG. 3A shows a sample equivalent circuit for one exemplary NPN B-TRAN. Body diodes 312A and 312B can correspond to e.g. the upper and lower P-N junctions, respectively. Switches 314A and 314B can short respective base terminals 108A and 108B to respective emitter/collector terminals 106A and 106B.

In one sample embodiment, a B-TRAN can have six phases of operation in each direction, as follows.

1) Initially, as seen in FIG. 3B, voltage on emitter/collector terminal T1 is positive with respect to emitter/collector terminal T2. Switches 314A and 316A are open, leaving base terminal B1 open. Switch 314B is closed, shorting base terminal B2 to emitter/collector terminal T2. This, in turn, functionally bypasses body diode 312B. In this state, the device is turned off. No current will flow in this state, due to the reverse-biased P-N junction (represented by body diode 312A) at the upper side of the device.

2) As seen in FIG. 3C, the voltage on emitter/collector terminal T1 is brought negative with respect to emitter/collector terminal T2. P-N diode junction 312A is now forward biased, and now begins injecting electrons into the drift region. Current flows as for a forward-biased diode.

After a short time, e.g. a few microseconds, the drift layer is well-charged. The forward voltage drop is low, but greater in magnitude than 0.7 V (a typical silicon diode voltage drop). In one sample embodiment, a typical forward voltage drop (Vf) at a typical current density of e.g. 200 A/cm2 can have a magnitude of e.g. 1.0 V.

3) To further reduce forward voltage drop Vf, the conductivity of the drift region is increased, as in e.g. FIG. 3D. To inject more charge carriers (here, holes) into the drift region, thereby increasing its conductivity and decreasing forward voltage drop Vf, base terminal B2 is disconnected from terminal T2 by opening switch 314B. Base terminal B2 is then connected to a source of positive charge by switch 316B. In one sample embodiment, the source of positive charge can be, e.g., a capacitor charged to +1.5 VDC. As a result, a surge current will flow into the drift region, thus injecting holes. This will in turn cause upper P-N diode junction 312A to inject even more electrons into the drift region. This significantly increases the conductivity of the drift region and decreases forward voltage drop Vf to e.g. 0.1-0.2 V, placing the device into saturation.

4) Continuing in the sample embodiment of FIG. 3D, current continuously flows into the drift region through base terminal B2 to maintain a low forward voltage drop Vf. The necessary current magnitude is determined by, e.g., the gain of equivalent NPN transistor 318. As the device is being driven in a high level injection regime, this gain is determined by high level recombination factors such as e.g. surface recombination velocity, rather than by low-level-regime factors such as thickness of, and carrier lifetime within, the base/drift region.

5) To turn the device off, as in e.g. FIG. 3E, base terminal B2 is disconnected from the positive power supply and connected instead to emitter terminal T2, opening switch 316B and closing switch 314B. This causes a large current to flow out of the drift region, which in turn rapidly takes the device out of saturation. Closing switch 314A connects base terminal B1 to collector terminal T1, stopping electron injection at upper P-N junction 312A. Both of these actions rapidly remove charge carriers from the drift region while only slightly increasing forward voltage drop Vf. As both base terminals are shorted to the respective emitter/collector terminals by switches 314A and 314B, body diodes 312A and 312B are both functionally bypassed.

An alternative version of this device, as described in U.S. Pat. No. 9,787,298, uses TWO pre-turnoff phases. The implementation of this is described in detail below.

6) Finally, at an optimum time (which can be e.g. nominally 2 μs for a 1200 V device), full turn-off can occur, as seen in e.g. FIG. 3F. Full turn-off can begin by opening switch 314B, disconnecting base terminal B2 from corresponding terminal T2. This causes a depletion region to form from lower P-N diode junction 312B as it goes into reverse bias. Any remaining charge carriers recombine, or are collected at the upper base. The device stops conducting and blocks forward voltage.

The procedure of steps 1-6 can, when modified appropriately, used to operate the device in the opposite direction. Steps 1-6 can also be modified to operate a PNP B-TRAN (e.g. by inverting all relevant polarities).

Note that, even though the B-TRAN is a four-terminal device, with two base contact regions which are operated separately, it operates as a three-layer device—i.e. it only has one base region. That is the center of the die's vertical extent, between the two emitter junctions. Since the B-TRAN is a symmetrically bipolar device, only one of the two emitter/collector regions will be operating as an emitter at any given moment; but the bottom junction of either emitter/collector region is referred to here, for convenience, as an “emitter junction.”

A somewhat similar structure was shown and described in application WO2014/113472 of Wood. However, that application is primarily directed to different structures. The Wood application also does not describe the methods of operation described in the US 2014-0375287 application.

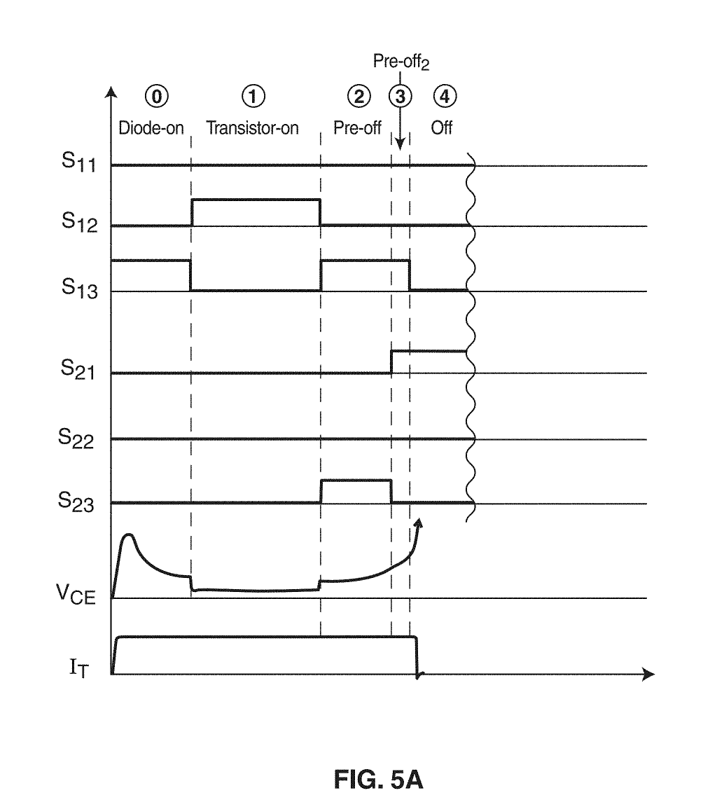

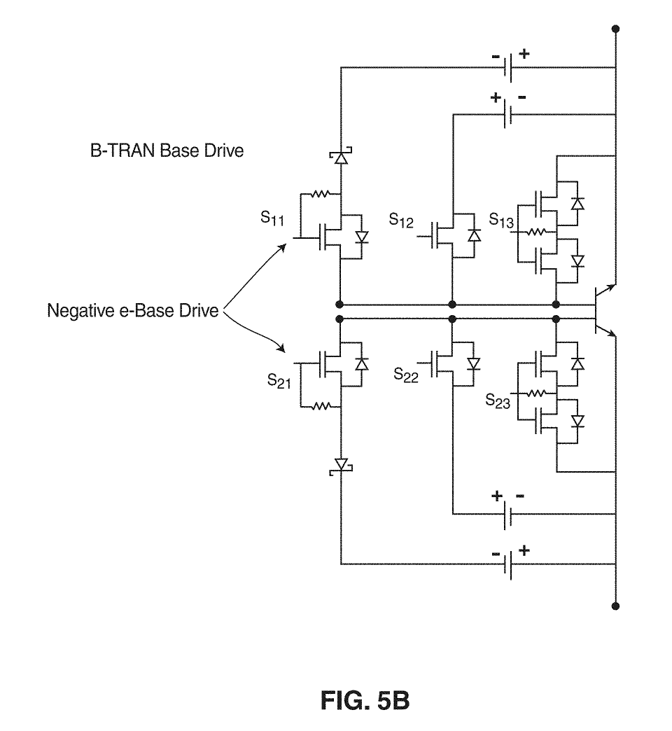

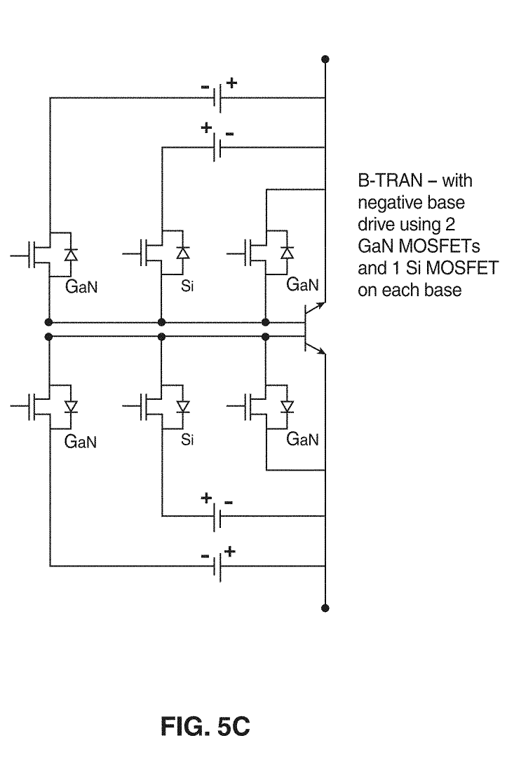

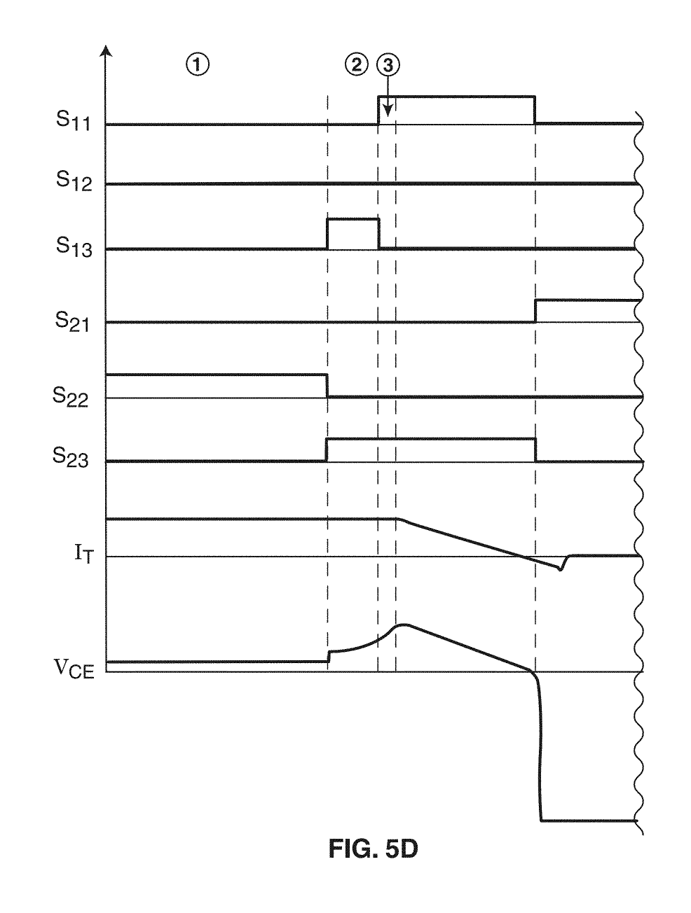

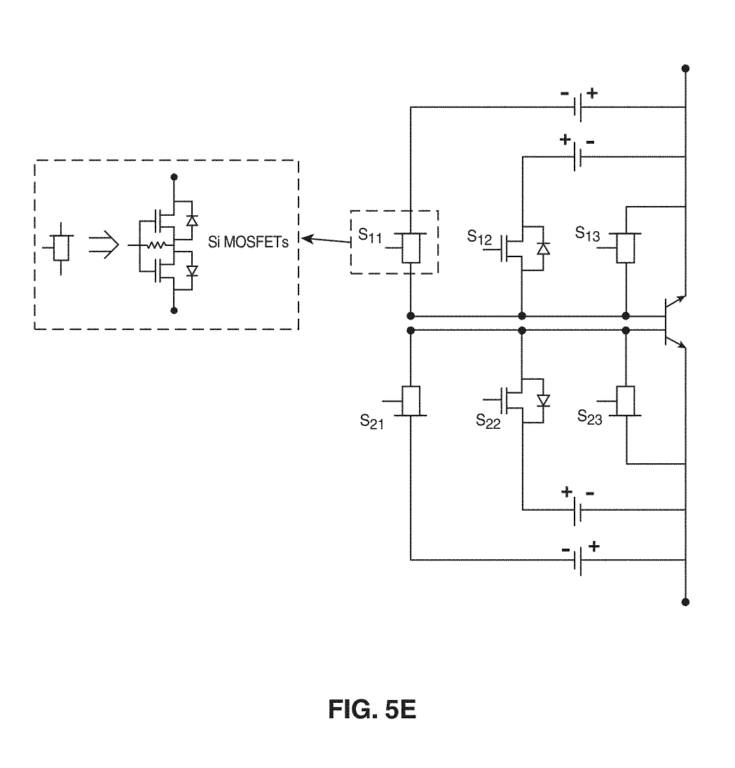

An improved version of this device, as described in U.S. Pat. No. 9,787,298, uses TWO pre-turnoff phases. The implementation of this is described with reference to FIGS. 5A-5E.

In one example of an NPN B-TRAN device, turn-off begins with a pre-turnoff stage as before, where each base contact region is shorted to its adjacent emitter/collector region. However, according to the additional disclosure in the present application, this first pre-turnoff stage is followed by a second pre-turnoff timing phase, where negative drive is applied to the e-base (i.e. to the base contact region on the same side as the emitter, which is the more negative of the two emitter/collector regions). This negative drive reduces the population of holes in the bulk base (which is the p-type bulk of the semiconductor material). Since the population of holes is reduced, secondary emission of electrons from the collector junction is also necessarily reduced, and the nonequilibrium ON-state carrier concentration moves toward its equilibrium value. (The nonequilibrium carrier concentration can be orders of magnitude greater than its equilibrium value.)

FIG. 5A shows waveform plots for one sample embodiment of turn-off switching using e.g. a base drive circuit like that of FIG. 5B. Note that, instead of the single pre-turnoff timing phase disclosed in previous applications, two pre-turnoff timing phases appear here. The two pre-turnoff timing phases are labeled as “Pre-off₁” (or phase 2) and “Pre-off₂” (or phase 3).

In the stage labeled “Pre-off₂”, switch S₂₁ turns on, briefly driving the e-base negative just before turn-off (which occurs in phase 5). This reduces turn-off losses.

The first timing phase illustrated (phase 0) is the “diode-on” mode. Here switch S₁₃ is connecting the c-base to the collector. This results in conduction subject to a “diode drop” (about 0.9V for silicon) of forward bias.

The second timing phase illustrated (phase 1) is the “transistor-on” mode. Here switch S₁₂ is connecting the c-base to a positive voltage with respect to the collector. This results in conduction subject to a very small forward bias (e.g. 200 mV or so of V_{CE}).

The third timing phase illustrated is the pre-turnoff timing phase “Pre-off₁” (or phase 2). In this timing phase both of the base contact regions are shorted to their adjacent emitter/collector regions.

The fourth timing phase illustrated is the second pre-turnoff timing phase “Pre-off₂” (or phase 3). In this timing phase the e-base is driven to reduce conduction; in a PNP device a negative drive is applied to the e-base, as described above.

The last timing phase illustrated is the “active-off” timing phase (phase 4). In this timing phase both of the base contact regions are shorted to their adjacent emitter/collector regions.

FIG. 5C shows another negative base drive circuit, which operates a B-TRAN (silicon in this example) using two GaN MOSFETs and one Si MOSFET on each base. Since the bandgap of GaN is higher than Si, the larger diode drop voltage (of the body diode) of the GaN MOSFETs provides a differential with respect to the body diodes of the silicon devices.

FIG. 5D shows waveform plots for one sample embodiment of reverse recovery switching for a negative base drive like e.g. that of FIG. 2. Here, the negative base drive briefly pulls the e-base negative to reduce turn-on and reverse recovery losses.

FIG. 5E shows another negative base drive circuit, which operates a B-TRAN using two Si MOSFET pairs and one Si MOSFET on each base.

The drive circuitry and sequence of FIGS. 5A-5E are not necessarily parts of the claimed invention. However, they are believed to have particular advantages in HVDC/MVDC breaker operation.

Additional general background, which helps to show variations and implementations, as well as some features which can be implemented synergistically with the inventions claimed below, may be found in the following US patent applications. All of these applications have at least some common ownership, copendency, and/or inventorship with the present application, and all of them, as well as any material directly or indirectly incorporated within them, are hereby incorporated by reference: U.S. Pat. Nos. 9,029,909, 9,035,350, 9,054,706, 9,059,710, 9,054,707, 9,209,798, 9,190,894, 9,209,713, 9,203,400, 9,203,401, 9,231,582, 9,787,298; US 2015-0214055 A1, US 2015-0214299 A1; U.S. Ser. No. 14/882,316, U.S. Ser. No. 14/918,440, U.S. Ser. No. 14/930,627, U.S. Ser. No. 14/935,336, U.S. Ser. No. 14/937,814, U.S. Ser. No. 14/945,097, U.S. Ser. No. 14/992,971, U.S. Ser. No. 14/957,516, U.S. Ser. No. 14/935,344, U.S. Ser. No. 14/935,349; and all priority applications of any of the above thereof, each and every one of which is hereby incorporated by reference.

Advantages

The disclosed innovations, in various embodiments, provide one or more of at least the following advantages. However, not all of these advantages result from every one of the innovations disclosed, and this list of advantages does not limit the various claimed inventions.
Improved efficiency in power transmission systems;
Improved efficiency in power distribution systems;
Increased power capacity for a given amount of conductors;
Compatibility with distributed-generation architectures; and/or
Compatibility with distributed grid storage.

According to some but not necessarily all embodiments, there is provided: A power distribution system method, comprising: in a primary distribution station, stepping down the voltage of power received from transmission lines, to thereby provide medium voltage DC power on primary distribution lines; supplying substations through respective circuit breakers which each comprise at least one series-connected combination of fully bidirectional bipolar transistors; and from the substations, supplying local loads and/or secondary substations through respective additional series-connected combinations of fully bidirectional bipolar transistors.

According to some but not necessarily all embodiments, there is provided: A power distribution system method, comprising: in a primary distribution station, stepping down the voltage of power received from transmission lines, to thereby provide medium voltage DC power on primary distribution lines; supplying substations through respective circuit breakers which each comprise at least one series-connected combination of fully bidirectional bipolar transistors; and, when a circuit breaker is to be opened, then first putting all of the transistors in a combination simultaneously into a pre-turnoff mode, and thereafter simultaneously turning off all of the transistors in the combination; and from the substations, supplying local loads and/or secondary substations through respective additional series-connected combinations of fully bidirectional bipolar transistors.

According to some but not necessarily all embodiments, there is provided: An electric power system, comprising: a generating station, which generates electrical power; a step-up unit, which steps up the voltage of the electrical power to provide power at high voltage onto transmission lines; a primary distribution station which steps down the voltage of power received from transmission lines, to thereby provide power at a primary distribution voltage on primary distribution lines; and multiple circuit breakers which connect the primary distribution lines to substations and/or customers; wherein the circuit breakers each comprise a series-connected combination of fully bidirectional bipolar transistors.

According to some but not necessarily all embodiments, there is provided: Methods and systems for HVDC and/or MVDC power transmission and/or distribution, using circuit breakers where a series-connected stack of fully-bidirectional bipolar junction transistors is the initial interrupter in the current path. Preferably these transistors are operated with two pre-turnoff phases, to deplete minority carrier population and thus provide a faster transition to complete turnoff.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Preferably, but not necessarily, these transistors (or a series combination of them) provide an HVDC breaker without any mechanical breaker at all. However, in alternative embodiments elements such as in the ABB system can be added to form a hybrid system.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A power distribution system method, comprising:
in a primary distribution station, stepping down the voltage of power received from transmission lines, to thereby provide medium voltage DC power on primary distribution lines;
supplying substations through respective circuit breakers which each comprise at least one series-connected combination of fully bidirectional bipolar transistors; and
from the substations, supplying local loads and/or secondary substations through respective additional series-connected combinations of fully bidirectional bipolar transistors.

2. The method of claim 1, wherein the transistors are B-TRANs.

3. The method of claim 1, wherein the stepping down converts HVDC power to MVDC power.

4. The method of claim 1, wherein, in each said circuit breaker, the transistors are all switched at the same time.

5. The method of claim 1, wherein at turn-off, in each said circuit breaker, the transistors are all switched at the same time into a pre-turn-off phase, and then are all switched at the same time into an off phase.

6. The method of claim 1, wherein at turn-off, in each said circuit breaker, the transistors are all switched at the same time into a first pre-turn-off phase, and then are all switched at the same time into a first pre-turn-off phase where reverse drive is applied to reduce, and then are all switched off at the same time.

7. The method of claim 1, wherein at turn-on, in each said circuit breaker, the transistors are all switched at the same time into operation as forward junction diodes, and then all receive base drive at the same time to lower their forward voltage drop.

8. A power distribution system method, comprising:
in a primary distribution station, stepping down the voltage of power received from transmission lines, to thereby provide medium voltage DC power on primary distribution lines;
supplying substations through respective circuit breakers which each comprise at least one series-connected combination of fully bidirectional bipolar transistors; and, when a circuit breaker is to be opened, then first putting all of the transistors in a combination simultaneously into a pre-turnoff mode, and thereafter simultaneously turning off all of the transistors in the combination; and
from the substations, supplying local loads and/or secondary substations through respective additional series-connected combinations of fully bidirectional bipolar transistors.

9. The method of claim 8, wherein the stepping down converts HVDC power to MVDC power.

10. The method of claim 8, wherein at turn-off, in each said circuit breaker, the transistors are all switched at the same time into a first pre-turn-off phase, and then are all switched at the same time into a first pre-turn-off phase where reverse drive is applied to reduce minority carrier density, and then are all switched off at the same time.

11. The method of claim 8, wherein at turn-on, in each said circuit breaker, the transistors are all switched at the same time into operation as forward junction diodes, and then all receive base drive at the same time to lower their forward voltage drop.

12. The method of claim 8, wherein the transistors are B-TRANs.

13. An electric power system, comprising:
a generating station, which generates electrical power;
a step-up unit, which steps up the voltage of the electrical power to provide power at high voltage onto transmission lines;
a primary distribution station which steps down the voltage of power received from transmission lines, to thereby provide power at a primary distribution voltage on primary distribution lines; and
multiple circuit breakers which connect the primary distribution lines to substations and/or customers;
wherein the circuit breakers each comprise a series-connected combination of fully bidirectional bipolar transistors.

14. The system of claim 13, wherein the transistors are B-TRANs.

15. The system of claim 13, wherein the primary distribution station steps down HVDC power to MVDC power.

16. The system of claim 13, wherein the step-up unit is a transformer.

17. The system of claim 13, wherein the step-up unit is a voltage-source converter.

18. The system of claim 13, further comprising a grid storage unit.

19. The system of claim 13, wherein each series-connected combination is paralleled by a voltage divider, and wherein multiple nodes of the series-connected combination are each connected to multiple nodes fo the voltage divider.

20. The system of claim 13, wherein the fully bidirectional bipolar transistors are three-layer four-terminal devices.
